(19) United States
(12) Patent Application Publication
(10) Pub. No.: US 2012/0297304 A1
(43) Pub. Date: Nov. 22, 2012

(54) Adaptive Operating System

(75) Inventor: Cynthia Maxwell, Portola Valley, CA (US)

(73) Assignee: APPLE INC., Cupertino, CA (US)

(21) Appl. No.: 13/109,961

(22) Filed: May 17, 2011

(51) Int. Cl. G09G 3/22; G06F 3/16

(52) U.S. Cl. 715/728; 345/589

(57) ABSTRACT

An adaptive operating system is described that adjusts a set of applications and/or a set of application icons presented on a user interface based on ambient noise and/or ambient light conditions at the mobile device. In some implementations, a sensor on a mobile device can detect the amount of ambient noise and/or light at the mobile device and adjust the presentation of sound-related and/or light-related applications or application icons on a graphical interface of the mobile device. In some implementations, a set of applications and/or a set of application icons presented on a user interface can be adjusted based on movement of the mobile device detected by a motion sensor of the mobile device.

### TECHNICAL FIELD

The disclosure generally relates to graphical user interfaces.

### BACKGROUND

Mobile devices, by virtue of their mobility, are used in many different environments. Mobile devices are used in noisy subways, sunlight parks, dark theaters and quiet homes. Sometimes the environment of the mobile device, whether noisy or quiet, brightly lit or dark, can make using software (e.g., various applications and features) of the mobile device difficult or inappropriate to use.

### SUMMARY

An adaptive operating system is described that adjusts a set of applications and/or a set of application icons presented on a user interface based on ambient noise and/or ambient light conditions at the mobile device. In some implementations, a sensor on a mobile device can detect the amount of ambient noise at the mobile device and adjust the presentation of sound-related applications or application icons on a graphical interface of the mobile device. In some implementations, a sensor on a mobile device can detect the amount of ambient light at the mobile device and adjust the presentation of light-related applications or application icons on a graphical interface of the mobile device. In some implementations, a set of applications and/or a set of application icons presented on a user interface can be adjusted based on movement of the mobile device detected by a motion sensor of the mobile device.

Particular implementations provide at least the following advantages: implementations conserve space on interfaces and increase usability of mobile devices by adjusting the interfaces of mobile devices to present environment appropriate applications based on environmental conditions of the mobile device.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example mobile device.

FIG. 2 illustrates an example interface of the mobile device.

FIG. 3 is a flow diagram of an example adaptive operating system process.

FIG. 4 is a flow diagram of an example adaptive operating system process.

FIG. 5 is a block diagram of an example mobile device architecture for implementing the features and processes of FIGS. 1-4.

Like reference symbols in the various drawings indicate like elements.

### DETAILED DESCRIPTION

### Example Mobile Device

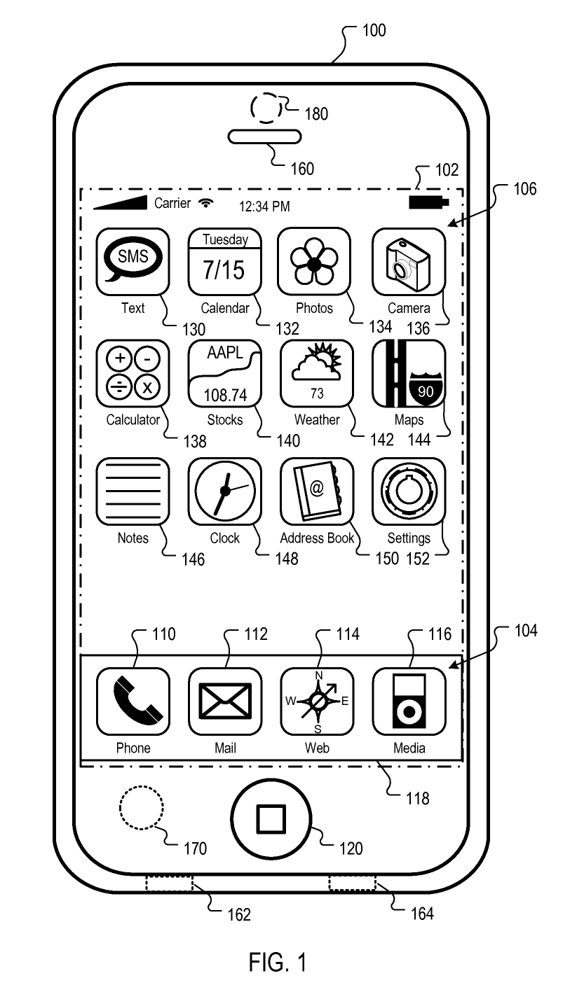

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106 are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114, or 116 can, for example, invoke corresponding functionality.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects (i.e., “home screen” collectively) displayed on the touch-sensitive display 102. The graphical user interface environment of FIG. 1 can be restored by pressing the “home” display object or by pressing button 120.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150, and 152 can invoke a corresponding object environment and functionality. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speaker phone functions. An audio jack 166 can also be included for use of headphones and/or a microphone.

In some implementations, an ambient light sensor 170 can be utilized to facilitate adjusting the brightness of the touch-sensitive display 102. For example, ambient light sensor 170 can detect the amount of light and adjust the brightness of the touch-sensitive display based on the amount of light detected.

The mobile device 100 can also include a camera lens and sensor 180. In some implementations, the camera lens and sensor 180 can be located on the back surface of the mobile device 100. The camera can capture still images and/or video.

### Adaptive Interface

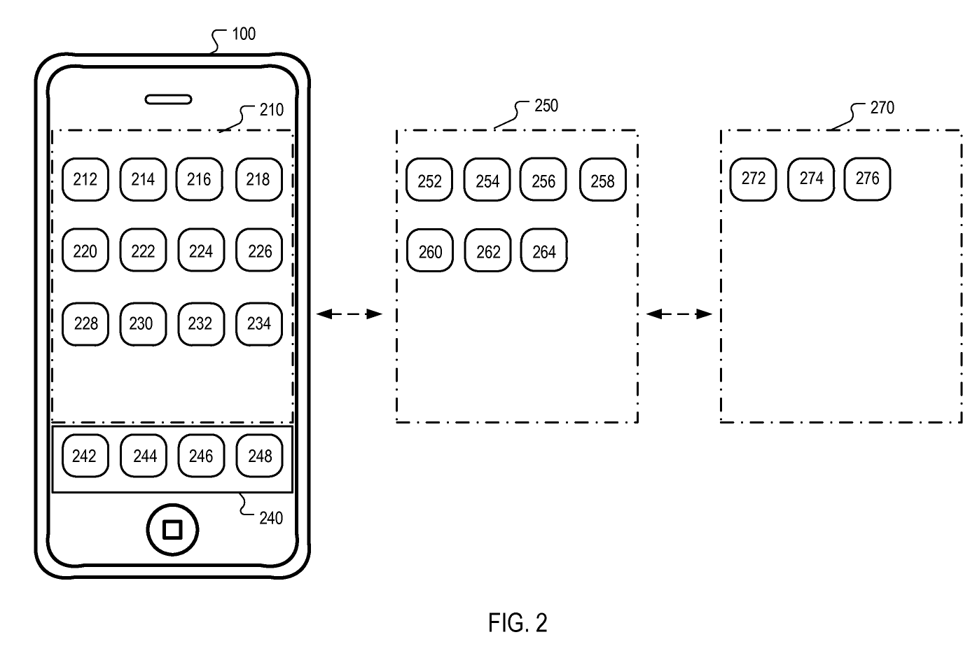

FIG. 2 illustrates an example graphical user interface of a mobile device 100. In some implementations, mobile device 100 can be configured to present various screens (e.g., screens 210, 250, 270) having different display objects. For example, mobile device 100 can display a home screen 210 that presents display objects 212, 214, 216, 218, 220, 222, 224, 226, 228, 230, 232 and 234. In some implementations, home screen 170 can be configured to be the first screen presented when a user invokes mobile device 100. In some implementations, mobile device 100 can be configured to display a dock for presenting specific display objects (e.g., display objects 242, 244, 246 and 248).

A user of mobile device 100 can cause additional screens 250 and 270 to individually appear on mobile device 100. For example, in response to user input (e.g., touch input, gesture, etc.) to device 100, additional screens 250 or 270 can be displayed. Screen 250 can present display objects 252, 254, 256, 258, 260, 262 and 264, for example. Screen 270 can present display objects 272, 274 and 276, for example. In some implementations, display objects 242, 244, 246 and 248 in dock 240 do not change as different screens (e.g., screens 210, 250, or 270) are presented on mobile device 100.

In some implementations, the display objects presented on screens 210, 250 and 270 and in dock 240 can be automatically adjusted based on detected ambient light and/or noise conditions at mobile device 100. In some implementations, the display objects presented on screens 210, 250 and 270 and in dock 240 can be automatically adjusted based detected movement of mobile device 100. For example, ambient noise can be detected using microphone 150. Ambient light can be detected using light sensor 160. Movement of mobile device 100 can be detected using a motion sensor (e.g., accelerometer) of mobile device 100. In some implementations, one or more of display objects can be moved to, removed from or replaced on a screen (e.g., home screen 210) based on detected ambient light, noise, and/or movement detected at mobile device 100. Likewise, one or more of display objects can be moved to, removed from or replaced on dock 240 based on detected ambient light, noise and/or movement detected at mobile device 100.

For example, if the amount of detected ambient light will prevent a camera application corresponding to display object 218 from properly capturing of images, display object 218 can be removed from home screen 210. Similarly, if the amount of ambient noise will impede perception of sound played by a media application (e.g., music player, video player) corresponding to display object 248, then display object 248 can be removed from dock 240. If the amount of device movement will make it difficult for a user to read text on the mobile device, then a display object corresponding to a digital book application can be removed from screen 210 or dock 240, for example. In some implementations, removed display objects (e.g., display object 218 or 248) can be replaced with display objects corresponding to applications appropriate for the ambient noise, ambient light and/or movement of mobile device 100.

In some implementations, display objects can be moved, removed, or replaced on a screen or dock based on a combination of sensor inputs. For example, if the amount of ambient noise will impede perception of sound played by a media application (e.g., music player, video player) corresponding to display object 248, then display object 248 can be removed from dock 240. However, if mobile device 100 detects that a user has plugged headphones into a headphone jack of mobile device 100, display object 248 can be preserved in dock 240. Thus, mobile device 100 can have a sensor that detects ambient noise and a sensor that detects the engagement of the headphone jack and based on input from the two sensors, determine how to display object 248. Similarly, input from the ambient light sensor can be combined with other sensor input to determine how to display various display objects of mobile device 100.

In some implementations, display objects can be automatically promoted to and/or demoted from screens 210, 250, 270 and dock 240. For example, dock 240 and screens 210, 250 and 270 can each be associated with a priority level. Dock 240 can be associated with the highest priority level (e.g., priority 1). Home screen 210 can be associated with a medium priority level (e.g., priority 2). Additional screens 250 and 270 can be associated with lower priority levels (e.g., priorities 3 and 4, respectively). In some implementations, promotion of display objects can be performed by moving a display object from a lower priority location (e.g., screen or dock) to a higher priority location. Promotion of objects can be performed by adding an object to home screen 210 or dock 240. For example, if an application exists on device 100 but no display object for the application is displayed on any screen or dock, a display object associated with the application can be added to a screen or dock based on ambient noise and/or light detected at mobile device 100.

In some implementations, display objects in additional screen 250 (e.g., priority 3) can be promoted to home screen 210 (e.g., priority 2) or promoted to dock 240 (e.g., priority 1) based on detected ambient noise and/or light. For example, if the amount of detected ambient light is low (e.g., there is no light), then display object 276 on additional screen 270 corresponding to a flashlight application can be promoted (e.g., moved) to dock 240 or the home screen 210 of mobile device 100. The flashlight object 276 can be added to the display objects on home screen 210 or dock 240 or can replace one of the display objects on home screen 210 or dock 240.

In some implementations, display objects in dock 240 (e.g., priority 1) can be demoted to home screen 210 (e.g., priority 2) or demoted to additional screens 250, 270 (e.g., priority 3, 4) based on detected ambient noise and/or light. For example, if the amount of detected ambient noise will prevent proper perception of sound played by a media application (e.g., music player, video player) corresponding to display object 248, then display object 248 can be demoted (e.g., moved) from dock 240 to the home screen 210 or an additional screen 250, 270 of mobile device 100.

Promotion and demotion of display objects can be performed to conserve display space and increase usability of mobile device 100. For example, display space can be conserved by removing display objects from user interfaces when the applications associated with the display objects are deemed to be unusable based on current ambient noise/light conditions detected at mobile device 100. Removing display objects frees up space on the display of mobile device 100 so that other display objects to be presented on the display. Usability can be increased by presenting display objects appropriate for the ambient noise/light conditions at mobile device 100 and hiding display objects that are inappropriate or unusable for the ambient noise/light conditions at mobile device 100.

In some implementations, other sensors of mobile device 100 can be used to adjust (e.g., promote or demote) the display of applications and icons on mobile device 100. For example, mobile device 100 can include a timekeeping mechanism (e.g., a clock) for tracking the time of day and applications and icons can be adjusted on mobile device 100 based on the time of day. A stock trading application, for example, can be promoted or demoted from a display on mobile device 100 based on the time of day and known trading hours of a stock exchange. Additionally, the time of day provided by the timekeeping mechanism can be correlated to user data stored on mobile device 100 to determine how to adjust applications and icons displayed on mobile device 100. For example, user data can include calendar entries. The calendar entries (e.g., appointments) can be categorized and the categories can be associated with applications on mobile device 100. When the time for the appointment arrives (as determined by the clock on mobile device 100), applications associated with the category assigned to the appointment can be promoted or demoted on a display (screen or dock) of mobile device 100. Additionally, an electronic book (e-book) application can be promoted or demoted based on movement of mobile device 100. For example, if mobile device is moving or shaking, the text of an e-book displayed on mobile device 100 may be difficult or impossible to read or may cause the reader to feel ill.

### Example Processes

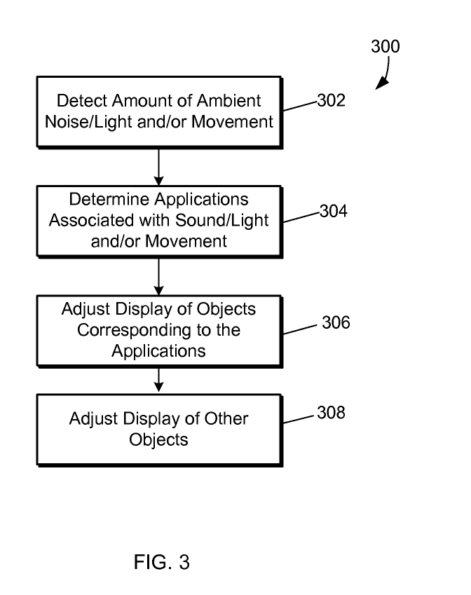

FIG. 3 is a flow diagram of an example adaptive operating system process 300 for adjusting interfaces of mobile device 100. At step 302, an amount of ambient noise, ambient light and/or movement is detected. For example, the amount of ambient noise at mobile device 100 can be detected with microphone 162 of FIG. 1. The amount of ambient light at mobile device 100 can be detected with light sensor 170, for example. In some implementations, microphone 162 and light sensor 170 can generate signals when light or sound is detected and the signals can be converted into data indicating an amount of detected ambient noise and/or light.

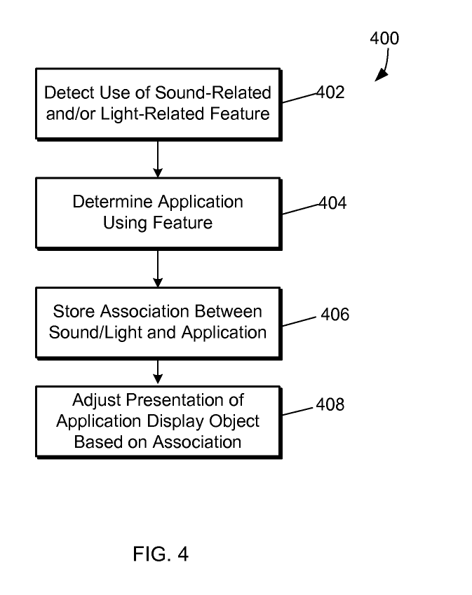

At step 304, applications associated with sound, light and/or movement are determined. For example, applications stored on mobile device 100 can be associated with metadata that describes an association between the application and sound/light. In some implementations, the metadata can be downloaded with the application when the application is downloaded. In some implementations, the metadata can be generated by mobile device 100, as described below with reference to FIG. 4.

In some implementations, the metadata for the application can identify the application, a display object for the application, light and/or noise requirements, or audio/visual device associations for the application. In some implementations, the metadata can specify an ambient light and/or ambient sound threshold for the application and a relationship (e.g., greater than, less than) between detected noise/light levels and the threshold value. In some implementations, if the ambient light/sound is greater than (or less than) a light/noise threshold specified in the metadata for the application, then the display object for the application can be moved from a home screen or dock to an additional screen or removed from display on the mobile device completely. In some implementations, mobile device 100 can be configured with default noise/light threshold values that can be used to adjust the display of display objects associated with applications when metadata for the applications does not specify threshold values for noise/light.

At step 306, display objects corresponding to the determined applications are adjusted. For example, the presentation of display objects corresponding to applications that are associated with noise/light requirements or that are associated with audio/visual input/output channels can be adjusted. For example, if metadata associated with an application specifies an ambient noise threshold value and the ambient noise detected at mobile device 100 is greater than (or less than) the threshold value, the display object corresponding to the application can be moved from one screen to another, from the dock to a screen, or from a screen to a dock, as described above with reference to FIG. 2. If the metadata does not specify a threshold value, the default threshold value configured on mobile device 100 can be used when the metadata indicates an association between the application and noise/light/sound or audio/video channels of mobile device 100.

For example, the aforementioned flashlight application can have metadata that indicates that the flashlight application uses a display output channel, uses a camera flash light output channel, or is associated with light output. The metadata for the flashlight application can set an ambient light threshold value. The metadata can indicate a less than relationship between the ambient light threshold value and detected ambient light such that if the detected ambient light is less than the ambient light threshold value the flashlight application can be promoted to the home screen or dock of mobile device 100. Promoting the flashlight application to the home screen or dock in low light conditions can make it easier for a user to access the flashlight application when the flashlight application is most likely to be used.

Likewise, metadata for an application associated with sound can identify an association between sound and the application, specify threshold values and threshold value relationships (e.g., greater than, less than). The presentation of display objects for sound-related applications can be adjusted (e.g., moved, removed, added, promoted, demoted) based on the metadata and the detected ambient noise at mobile device 100.

At step 308, other display objects can be adjusted. In some implementations, display objects for other applications can be adjusted to fill in spaces in the home screen or dock when a noise-related or sound-related application display object has been removed from the home screen or dock. For example, another application display object can be promoted into a space created in the home screen display or the dock when an application display object in the home screen or dock has been demoted based on detected ambient noise or sound. The application display object can be promoted based on sound/noise criteria, as discussed above. The application display object can be promoted based on usage statistics (e.g., frequency of use, application used more frequently than other applications) stored at mobile device 100. For example, mobile device 100 can track and store usage statistics for applications on device 100 and determine which applications to promote to higher priority level displays (e.g., home screen, dock, etc.) based on the usage statistics.

FIG. 4 is a flow diagram of an example adaptive operating system process 400 for generating metadata for display objects and applications. In some implementations, mobile device 100 can monitor usage of sound-related and/or light-related features of mobile device 100 and determine sound-related and/or light-related applications based on the use.

At step 402, use of a sound-related and/or light-related feature of mobile device 100 detected. In some implementations, mobile device 100 can detect signals transmitted on one or more input/output channels of mobile device 100. For example, mobile device 100 can detect when microphone 162 is receiving audio input by detecting signals generated by microphone 162. In some implementations, mobile device 100 can detect an invocation of an operating system application programming interface (API) related to one or more input/output channels. For example, mobile device 100 can detect invocation of an operating system API related to displaying video on touch-sensitive display 102. Mobile device 100 can detect invocation of an operating system API related to capturing images with camera lens and sensor 180.

In some implementations, mobile device 100 can determine sound-related and/or light-related activities on mobile device 100 based on the detected signals and/or API invocations. For example, if activity associated with a light-related API (e.g., camera API) or device (e.g., display signals) is detected, mobile device 100 can determine that the activity is light-related. Similarly, if activity associated with a sound-related API (e.g., speaker API) or device (e.g., microphone signals) is detected, mobile device 100 can determine that the activity is sound-related.

At step 404, an application using the sound-related and/or light-related feature of mobile device 100 is determined. For example, mobile device 100 can determine which application has accessed a sound-related API (e.g., speaker API). Mobile device 100 can determine which application is causing signals to be sent to or received from a light-related sensor (e.g., camera lens and sensor 180). The application determination can be made based on which application is actively running or is currently presented on mobile device 100. The application determination can be made by collecting process stack information. The application determination can be made by collecting data about the application within the operating system API by using programming hooks or other known mechanisms, for example.

At step 406, an association between sound and/or light and the determined application is stored. For example, once the application that caused the activity on the input/output channel is determined, an association between the application and the input/output channel can be stored as metadata for the application. In some implementations, the association is a categorization of the determined application. For example, an application can be categorized as a sound-related or light-related application based on the input/output channels that the application uses. Applications can be categorized as light-related if they interact with various light-related features and or sensors of mobile device 100. For example, an application that generates output to a display can be categorized as a light-related application. Other light-related features of mobile device 100 can include camera sensor and lens 180 and light sensor 170. Applications can be categorized as sound-related if they interact with various sound-related features and or sensors of mobile device 100. An application that generates output to a speaker can be categorized as a sound-related application. Other sound-related features of mobile device 100 can include speaker 160, loud speaker 164 and microphone 162. The categorization can be stored as metadata for the application.

At step 408, the presentation of an application display object can be adjusted based on the stored association. For example, if an association exists between an application and a light-related feature or sensor of mobile device 100, then a display object for the application can be adjusted when ambient light is detected. If the application is categorized as a sound-related application, then a display object for the application can be adjusted when ambient noise is detected. In some implementations, if the metadata for an application is automatically generated using the detection mechanisms of process 400, then the default threshold values for light and/or noise can be used to determine when to adjust application display objects, as described above with reference to FIG. 3.

Although implementations are described with reference to mobile device 100 of FIG. 1, implementations can include other computing devices, such as laptop and desktop computers. For example, laptop computers can include sound-related and light-related features (e.g., microphones, light sensors, cameras, speakers, displays, etc.). Moreover, display objects (e.g., icons) can be used on other computing devices to provide access to corresponding applications available on the computing devices. These computing devices can provide graphical user interfaces for presenting and selecting display objects to invoke applications. The presentation of application display objects presented on these computing devices can be adjusted based on detected ambient light and/or noise, as described above with reference to FIGS. 1-4.

### Example Mobile Device Architecture

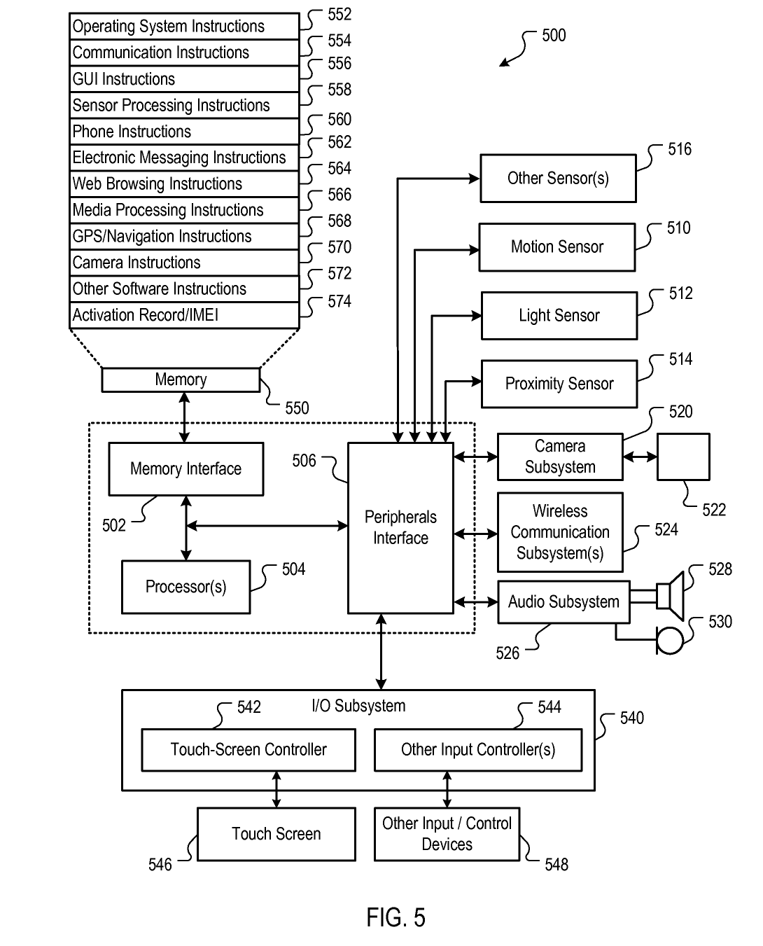

FIG. 5 is a block diagram 500 of an example implementation of the mobile device 100 of FIGS. 1-4. The mobile device 100 can include a memory interface 502, one or more data processors, image processors and/or central processing units 504, and a peripherals interface 506. The memory interface 502, the one or more processors 504 and/or the peripherals interface 506 can be separate components or can be integrated in one or more integrated circuits. The various components in the mobile device 100 can be coupled by one or more communication buses or signal lines.

Sensors, devices, and subsystems can be coupled to the peripherals interface 506 to facilitate multiple functionalities. For example, a motion sensor 510, a light sensor 512, and a proximity sensor 514 can be coupled to the peripherals interface 506 to facilitate orientation, lighting, and proximity functions. Other sensors 516 can also be connected to the peripherals interface 506, such as a positioning system (e.g., GPS receiver), a temperature sensor, a biometric sensor, or other sensing device, to facilitate related functionalities.

A camera subsystem 520 and an optical sensor 522, e.g., a charged coupled device (CCD) or a complementary metal-oxide semiconductor (CMOS) optical sensor, can be utilized to facilitate camera functions, such as recording photographs and video clips. The camera subsystem 520 and the optical sensor 522 can be used to collect images of a user to be used during authentication of a user, e.g., by performing facial recognition analysis.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which the mobile device 100 is intended to operate. For example, a mobile device 100 can include communication subsystems 524 designed to operate over a GSM network, a GPRS network, an EDGE network, a Wi-Fi or WiMax network, and a Bluetooth™ network. In particular, the wireless communication subsystems 524 can include hosting protocols such that the device 100 can be configured as a base station for other wireless devices. An audio subsystem 526 can be coupled to a speaker 528 and a microphone 530 to facilitate voice-enabled functions, such as speaker recognition, voice replication, digital recording, and telephony functions.

The I/O subsystem 540 can include a touch screen controller 542 and/or other input controller(s) 544. The touch-screen controller 542 can be coupled to a touch screen 546. The touch screen 546 and touch screen controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of the speaker 528 and/or the microphone 530.

In one implementation, a pressing of the button for a first duration can disengage a lock of the touch screen 546; and a pressing of the button for a second duration that is longer than the first duration can turn power to the mobile device 100 on or off. Pressing the button for a third duration can activate a voice control, or voice command, module that enables the user to speak commands into the microphone 530 to cause the device to execute the spoken command. The user can customize a functionality of one or more of the buttons. The touch screen 546 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™ The mobile device 100 can, therefore, include a 36-pin connector that is compatible with the iPod. Other input/output and control devices can also be used.

The memory interface 502 can be coupled to memory 550. The memory 550 can include high-speed random access memory and/or non-volatile memory, such as one or more magnetic disk storage devices, one or more optical storage devices, and/or flash memory (e.g., NAND, NOR). The memory 550 can store an operating system 552, such as Darwin, RTXC, LINUX, UNIX, OS X, WINDOWS, or an embedded operating system such as VxWorks.

The operating system 552 can include instructions for handling basic system services and for performing hardware dependent tasks. In some implementations, the operating system 552 can be a kernel (e.g., UNIX kernel). In some implementations, the operating system 552 can include instructions for performing features described with reference to FIGS. 1-4.

The memory 550 can also store communication instructions 554 to facilitate communicating with one or more additional devices, one or more computers and/or one or more servers. The memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes and instructions; and/or camera instructions 570 to facilitate camera-related processes and functions.

The memory 550 can store other software instructions 572 to facilitate other processes and functions, such as the processes and functions as described with reference to FIGS. 1-4. The memory 550 can also store other software instructions (not shown), such as web video instructions to facilitate web video-related processes and functions; and/or web shopping instructions to facilitate web shopping-related processes and functions. In some implementations, the media processing instructions 566 are divided into audio processing instructions and video processing instructions to facilitate audio processing-related processes and functions and video processing-related processes and functions, respectively. An activation record and International Mobile Equipment Identity (IMEI) 574 or similar hardware identifier can also be stored in memory 550.

Each of the above identified instructions and applications can correspond to a set of instructions for performing one or more functions described above. These instructions need not be implemented as separate software programs, procedures, or modules. The memory 550 can include additional instructions or fewer instructions. Furthermore, various functions of the mobile device 100 can be implemented in hardware and/or in software, including in one or more signal processing and/or application specific integrated circuits.

What is claimed is:

1. A method comprising:
causing one or more graphical objects corresponding to one or more applications to display on a user interface of a device;
detecting an amount of ambient light at the device;
in response to detecting the amount of ambient light, determining an application in the one or more applications that is associated with light; and
adjusting a display of a graphical object in the one or more graphical objects that corresponds to the application.

2. The method of claim 1, further comprising:
determining that the application has at least one feature that conflicts with the amount of ambient light.

3. The method of claim 1, further comprising:
removing the graphical object from the display.

4. The method of claim 1, further comprising:
replacing the graphical object with another graphical object.

5. The method of claim 1, wherein the one or more graphical objects are selectable to invoke the corresponding one or more applications.

6. The method of claim 1, further comprising:
determining a value representing the amount of ambient light;
comparing the value to an ambient light threshold value; and
adjusting the display of the graphical object based on the comparison.

7. The method of claim 1, further comprising:
storing metadata for each of the one or more applications, the metadata identifying an ambient light threshold value; and
adjusting the display of the graphical object based on the stored metadata.

8. The method of claim 1, further comprising:
storing information associating each of the one or more applications with light;
adjusting the display of the graphical object based on the stored information.

9. The method of claim 1, wherein detecting the amount of ambient light comprises receiving signals from one or more sensors of the device.

10. A method comprising:
causing one or more graphical objects corresponding to one or more applications to display on a user interface of a device;
detecting an amount of ambient noise at the device;
in response to detecting the amount of ambient noise, determining an application in the one or more applications that is associated with sound; and
adjusting a display of a graphical object in the one or more graphical objects that corresponds to the application.

11. The method of claim 10, further comprising:
determining that the application has at least one feature that conflicts with the amount of ambient noise.

12. The method of claim 10, further comprising:
removing the graphical object from the display.

13. The method of claim 10, further comprising:
replacing the graphical object with another graphical object.

14. The method of claim 10, wherein the one or more graphical objects are selectable to invoke the corresponding one or more applications.

15. The method of claim 10, further comprising:
determining a value representing the amount of ambient noise;
comparing the value to an ambient noise threshold value; and
adjusting the display of the graphical object based on the comparison.

16. The method of claim 10, further comprising:
storing metadata for each of the one or more applications, the metadata identifying an ambient noise threshold value; and
adjusting the display of the graphical object based on the stored metadata.

17. The method of claim 10, further comprising:
storing information associating each of the one or more applications with sound;
adjusting the display of the graphical object based on the stored information.

18. The method of claim 10, wherein detecting the amount of ambient noise comprises receiving signals from one or more sensors of the device.

19. A non-transitory computer-readable medium including one or more sequences of instructions which, when executed by one or more processors, causes:
causing one or more graphical objects corresponding to one or more applications to display on a user interface of a device;
detecting an amount of ambient light at the device;
in response to detecting the amount of ambient light, determining an application in the one or more applications that is associated with light; and
adjusting a display of a graphical object in the one or more graphical objects that corresponds to the application.

20. A non-transitory computer-readable medium including one or more sequences of instructions which, when executed by one or more processors, causes:
causing one or more graphical objects corresponding to one or more applications to display on a user interface of a device;
detecting an amount of ambient noise at the device;
in response to detecting the amount of ambient noise, determining an application in the one or more applications that is associated with sound; and
adjusting a display of a graphical object in the one or more graphical objects that corresponds to the application.
